(19) United States
(12) Patent Application Publication
(10) Pub. No.: US 2025/0319841 A1
(43) Pub. Date: Oct. 16, 2025

(54) SYSTEMS AND METHODS FOR DETECTING PASSENGER RESTRAINT DEVICE USAGE

(71) Applicant: Toyota Motor Engineering & Manufacturing North America, Inc., Plano, TX (US)

(72) Inventors: John D. Harkleroad, Ypsilanti, MI (US); Vasudeva S. Murthy, Ann Arbor, MI (US); Jennifer Lyn Pelky, Brighton, MI (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 18/631,134

(22) Filed: Apr. 10, 2024

(51) Int. Cl. B60R 22/48; G01S 13/88

(52) U.S. Cl. CPC B60R 22/48; G01S 13/88; B60R 2022/4825; B60R 2022/4866

(57) ABSTRACT

Systems, methods, and other embodiments described herein relate to ensuring proper usage of passenger restraint devices. In one embodiment, a method includes controlling the millimeter-wave (mm-wave) radar sensor to transmit mm-wave radar waves toward a seat of a vehicle. The method also includes 1) detecting, from reflected mm-wave radar waves, an arrangement of a concealed metallic marker within a passenger restraint device of the seat relative to a passenger in the seat and 2) estimating an expected arrangement of the passenger restraint device relative to the passenger. A notification is generated responsive to the reflected mm-wave radar waves indicating that the arrangement of the passenger restraint device is different than the expected arrangement of the passenger restraint device.

### TECHNICAL FIELD

The subject matter described herein relates, in general, to passenger restraint devices and, more particularly, to detecting whether a passenger restraint device usage departs from an expected, and therefore safe, usage.

### BACKGROUND

There are inherent dangers when traveling on a roadway in a vehicle. This is in part due to the size, weight, and speed of various vehicles on a roadway. For example, heavy passenger and commercial vehicles may travel on a highway at speeds greater than 50 miles per hour, sometimes within a few feet of other vehicles traveling in the same or opposite directions. The road infrastructure is also occupied by other objects, both stationary, such as stop lights, barriers, etc. and dynamic, such as pedestrians, bicyclists, etc. Even when vehicle drivers exercise constant vigilance, collisions may still result.

Accordingly, vehicles may be equipped with certain systems and devices that work to prevent the occurrence of these incidents and that reduce the risk of harm to occupants when these incidents occur. Passenger movement relative to a vehicle during a crash may cause the passenger to be ejected from the vehicle or violently and jarringly shifted within the vehicle. Either situation is undesirable due to the potential harm to the passenger. Accordingly, a vehicle may include passenger restraint devices that hold a passenger in place to prevent the likelihood and severity of such crash-related movements to the body of the passenger. However, the effectiveness of passenger restraint devices may suffer due to improper use.

### SUMMARY

In one embodiment, example systems and methods relate to a manner of improving passenger safety by ensuring proper and expected use of passenger restraint devices within a vehicle.

In one embodiment, a restraint detection system for detecting proper usage of vehicle passenger restraint devices is disclosed. The restraint detection system includes a millimeter-wave (mm-wave) radar sensor and one or more processors and a memory communicably coupled to the one or more processors. The memory stores instructions that, when executed by the one or more processors, cause the one or more processors to 1) control the mm-wave radar sensor to transmit mm-wave radar waves towards a seat of a vehicle and 2) detect, from reflected mm-wave radar waves, an arrangement of a concealed metallic marker within a passenger restraint device of the seat relative to a passenger in the seat. The memory also stores instructions that, when executed by the one or more processors, cause the one or more processors to 1) estimate an expected arrangement of the passenger restraint device relative to the passenger and 2) generate a notification responsive to the reflected mm-wave radar waves indicating that the arrangement of the passenger restraint device is different than the expected arrangement of the passenger restraint device.

In one embodiment, a non-transitory computer-readable medium for detecting proper usage of vehicle passenger restraint devices and including instructions that, when executed by one or more processors, cause the one or more processors to perform one or more functions is disclosed. The instructions include instructions to 1) control a mm-wave radar sensor to transmit mm-wave radar waves towards a seat of a vehicle and 2) detect, from reflected mm-wave radar waves, an arrangement of a concealed metallic marker within a passenger restraint device of the seat relative to a passenger in the seat. The instructions also include instructions to 1) estimate an expected arrangement of the passenger restraint device relative to the passenger and 2) generate a notification responsive to the reflected mm-wave radar waves indicating that the arrangement of the passenger restraint device is different than the expected arrangement of the passenger restraint device.

In one embodiment, a method for detecting proper usage of vehicle passenger restraint devices is disclosed. In one embodiment, the method includes 1) controlling a mm-wave radar sensor to transmit mm-wave radar waves towards a seat of a vehicle and 2) detecting, from reflected mm-wave radar waves, an arrangement of a concealed metallic marker within a passenger restraint device of the seat relative to a passenger in the seat. The method also includes 1) estimating an expected arrangement of the passenger restraint device relative to the passenger and 2) generating a notification responsive to the reflected mm-wave radar waves indicating that the arrangement of the passenger restraint device differs from the expected arrangement of the passenger restraint device.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of a restraint detection system detecting improperly worn passenger restraint devices.

FIG. 2 illustrates one embodiment of a vehicle within which systems and methods disclosed herein may be implemented.

FIG. 3 illustrates one embodiment of a restraint detection system that is associated with detecting the characteristics of passenger restraint device usage.

FIG. 4 illustrates a flowchart for one embodiment of a method that is associated with detecting passenger restraint device usage characteristics.

FIG. 5 illustrates one embodiment of a restraint detection system detecting passenger restraint device usage characteristics.

FIGS. 6A and 6B illustrate one embodiment of a restraint detection system detecting whether or not a passenger restraint device is improperly worn.

FIG. 7A-7D illustrate one embodiment of a restraint detection system associated with detecting the characteristics of passenger restraint device usage.

FIG. 8 illustrates one embodiment of a restraint detection system detecting an improperly used child restraint device.

### DETAILED DESCRIPTION

Systems, methods, and other embodiments associated with improving passenger safety by evaluating passenger restraint device usage characteristics and determining whether such usage aligns with manufacturer and safety recommendations are disclosed herein. As previously described, vehicular travel is associated with inherent risks due to the size, speed, and quantity of vehicles that populate the roadways of the world. Vehicles may include various safety systems to reduce the likelihood and severity of potential collisions. Such systems include preventative systems that aim to avoid scenarios likely to result in a collision, while others reduce the harm or potential harm that may arise when an incident does occur.

For example, vehicles may be equipped with passenger restraint devices such as safety belts and child restraint systems that hold a passenger in place in the event of an incident. A passenger not held in place may abruptly and jarringly be dislodged from their seat during an accident, which may cause serious injury or place the passenger in an even more dangerous situation. However, these passenger restraint devices lose efficacy if misused. For example, an over-the-shoulder safety belt that is positioned against a passenger's neck may, while retaining the passenger in place, be a hazard to the passenger as an abrupt movement of the passenger during a collision could cause the safety belt to cut off airflow through the passenger's windpipe. As another example, an over-the-shoulder safety belt placed under the arm of the passenger loses some ability to hold the trunk of the passenger in place. This complication also arises in child restraint devices such as those in a child car seat inserted into a vehicle. Child restraint devices may include shoulder straps, a head restraint device, and/or a 5-point harness. Shoulder straps and/or head restraints that are too low or too high may lose their intended effect of restricting the movement of the chest and/or head of the child in the car seat.

Some vehicles include devices that detect whether or not a passenger restraint device is being used. As an example, a vehicle may include a safety belt buckle switch that detects whether the passenger restraint device is buckled or not. However, such systems may be bypassed and may not fully ensure proper and safe use of a passenger restraint device. For example, a buckle-based detection system may not detect a passenger who has draped the over-the-shoulder strap under their arm or a safety belt that is not snug against the trunk of the passenger. These buckle-based systems may also be expensive, thus precluding their implementation on all vehicle seats. Some vehicles incorporate camera or electromagnetic sensor-based systems to determine whether a passenger restraint device is in use. However, these systems rely on line-of-sight and thus may not be able to detect passenger restraint use behind an obscuring object such as a passenger's appendage, an article of clothing, and/or a blanket draped over a child.

Accordingly, the present specification presents a millimeter-wave (mm-wave) radar-based system that detects whether the passengers of a vehicle are utilizing a passenger restraint device and, more particularly, whether they are using the passenger restraint device in an expected fashion, where the expected fashion coincides with legal, regulatory, manufacturer, or safety guidelines. Specifically, the present restraint detection system utilizes a cabin-mounted mm-wave radar sensor which is capable of permeating through materials such as fabric, clothing, seat coverings, and the like to detect the characteristics (e.g., location, position, etc.) of a passenger restraint device notwithstanding the passenger restraint device being visually obscured by some object. A metallic marker, such as a metallic thread or wire, may be embedded and concealed within the passenger restraint device to aid in detecting the characteristics of the passenger restraint device. The mm-wave radar sensor may scan the cabin of the vehicle to detect the presence of these metallic markers. Various characteristics, such as location, position, and the quantity of extended restraint device sections, may be determined from the reflected mm-wave radar waves even when clothing, seat covers, blankets, and other fabrics visually occlude the passenger restraint device. When the restraint detection system determines the passenger restraint is not in use, the restraint detection system generates an alert notifying occupants of such non-use.

In one particular example, the restraint detection system not only determines whether a passenger restraint device is being used, but also determines whether the passenger restraint device is worn correctly based on a passenger's size, height, posture, position, etc. In one particular example, metallic threads may be embedded within the passenger restraint device in a particular pattern, with the pattern varying along the length of the passenger restraint device (e.g., the pattern along the first meter of the restraint device is different from that along the second meter, and the pattern along the third meter of the restraint device is different from those of the first and second meters). In this example, the restraint detection system determines how much of the passenger restraint device is extended based on the length-based metallic thread pattern. Based on the size of the passenger, the system determines, in some examples using machine learning, how much of the passenger restraint device is expected to be extended and compares the expected amount to a detected amount to determine whether or not the passenger is utilizing the restraint in a designated fashion (i.e., coincident with legal, manufacturer, and/or safety guidelines). If not, a warning would be presented indicating such.

In an example, the system is implemented to ensure the safety of a child. For example, a vehicle seat may be too large for a child. Accordingly, a child car seat may be positioned on top of and secured to a vehicle seat to ensure the safety of small children in a vehicle. These child car seats may have devices like head restraints, shoulder straps, chest straps, and/or a five-point buckle. As with vehicle safety belts, child restraint devices in a child car seat, if improperly used, may have a reduced capability to prevent and/or reduce the severity of an injury resulting from an incident. In this example, similar marker-embedded passenger restraint devices may be detected by a mm-wave radar sensor. In this example, the system, relying on the mm-wave wave radar or another in-cabin sensor, may detect the height of the child's head and/or shoulders. The output of the mm-wave radar sensor is processed, in some examples via a machine-learning module, to determine whether the position of these elements (e.g., head restraints, shoulder straps, and buckles) with respect to a determined head and/or shoulder position is in line with safety guidelines. As in the above examples, alert messages may be generated based on the results of the analysis of the reflected mm-wave waves, for example, requesting an adjustment to the child restraint devices. In each of these examples, the metallic marker is concealed or hidden within the associated passenger restraint devices to prevent damage to the metallic marker, prevent potentially undesirable contact of the metallic material with a passenger (e.g., a child), and provide a desired aesthetic.

In this way, the disclosed systems, methods, and other embodiments improve vehicle passenger safety by detecting whether passenger restraint devices are being used as intended (e.g., conforming to regulations, laws, and/or manufacturer or safety guidelines). Such detection is done regardless of whether a passenger restraint device is visually obscured (e.g., under fabric, seat covers, clothing, baby carrier visors, etc.) by using a mm-wave radar sensor, for example, a 60 gigahertz (GHz) radar sensor. In some examples, the system includes multiple output (e.g., transmit) channels and multiple input (e.g., receive) channels to increase the resolution and accuracy of restraint device detection.

Still further, the system improves vehicle passenger safety by using a length-based pattern within the passenger restraint device to determine whether an appropriate amount of the passenger restraint device is extended based on the physical characteristics of the restrained passenger. This improvement may ensure that child car seats within a vehicle are being properly utilized. The system is also simple and cost-effective, thus facilitating its use on all vehicle seats rather than just the driver and front passenger seats.

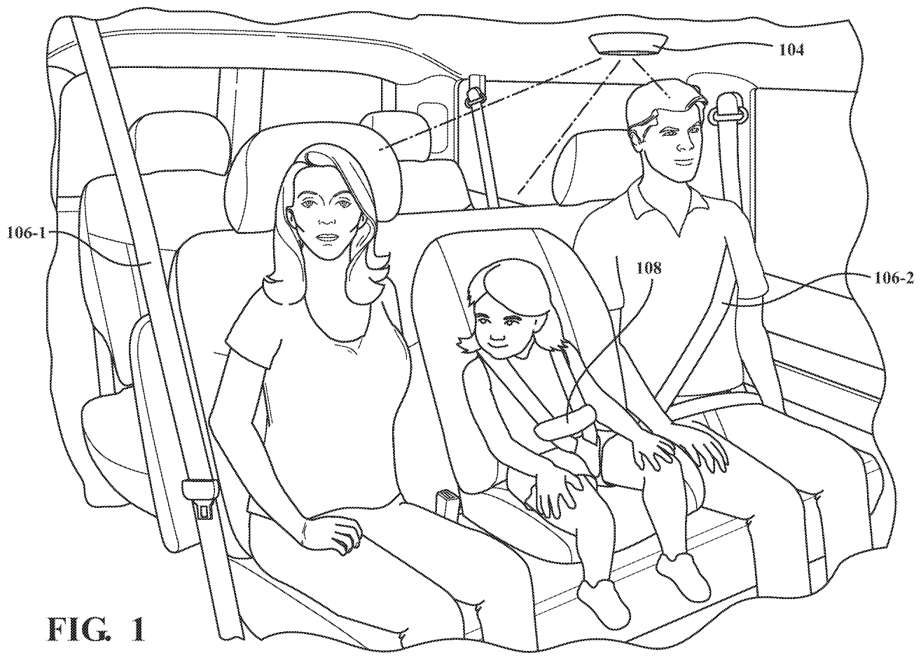

FIG. 1 illustrates one embodiment of a mm-wave radar sensor 104 detecting improperly worn passenger restraint devices. As described above, various types of passenger restraint devices may be used in a vehicle to promote the safety of vehicle passengers. In one example, the passenger restraint device is a vehicle safety belt 106. In another example, the passenger restraint device is any of the restraint devices in a child car seat such as a head restraint of the child seat, a shoulder strap of the child seat, or a buckle 108 of the child car seat. As used herein, a child car seat may be defined as a separate seat placed upon and, in some cases, secured to a vehicle seat installed in a vehicle. In either of these examples, the mm-wave radar sensor 104 of the restraint detection system detects an arrangement of concealed metallic markers in any of the aforementioned passenger restraint devices.

As described above, incorrect usage of the passenger restraint device may reduce its efficacy and, in some cases, may increase the injury risk of the passenger. For example, a safety belt 106-1 that is not worn provides no passenger safety. As another example, a buckle 108 of a child car seat that is too low on a trunk of a child may not be able to hold the child in place during an incident. As another example, a safety belt 106-2 that is worn but improperly so (e.g., below the shoulder rather than over the shoulder) may not hold the associated passenger in place as firmly were the safety belt 106-2 properly worn.

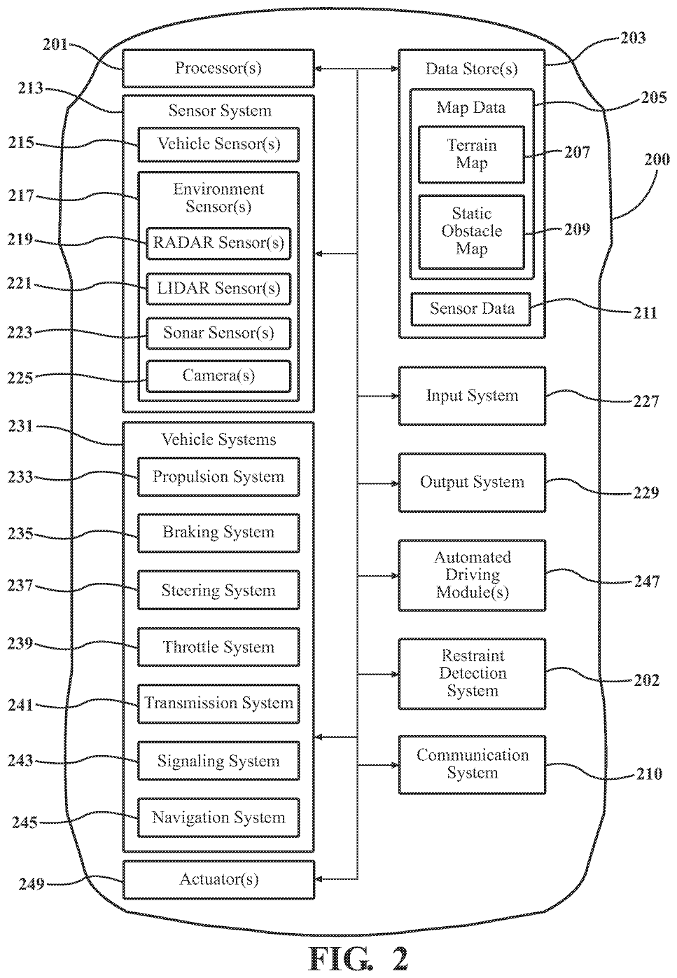

Referring to FIG. 2, an example of a vehicle 200 is illustrated. As used herein, a “vehicle” is any form of transport that may be motorized or otherwise powered. In one or more implementations, the vehicle 200 is an automobile. While arrangements will be described herein with respect to automobiles, it will be understood that embodiments are not limited to automobiles. In some implementations, the vehicle 200 may be a robotic device or a form of transport that, for example, transports passengers and thus benefits from the functionality discussed herein associated with ensuring passenger safety via conforming usage of passenger restraint devices.

The vehicle 200 also includes various elements. It will be understood that in various embodiments it may not be necessary for the vehicle 200 to have all of the elements shown in FIG. 2. The vehicle 200 can have different combinations of the various elements shown in FIG. 2. Further, the vehicle 200 can have additional elements to those shown in FIG. 2. In some arrangements, the vehicle 200 may be implemented without one or more of the elements shown in FIG. 2. While the various elements are shown as being located within the vehicle 200 in FIG. 2, it will be understood that one or more of these elements can be located external to the vehicle 200. Further, the elements shown may be physically separated by large distances. For example, as discussed, one or more components of the disclosed system can be implemented within a vehicle while further components of the system are implemented within a cloud-computing environment or other system that is remote from the vehicle 200.

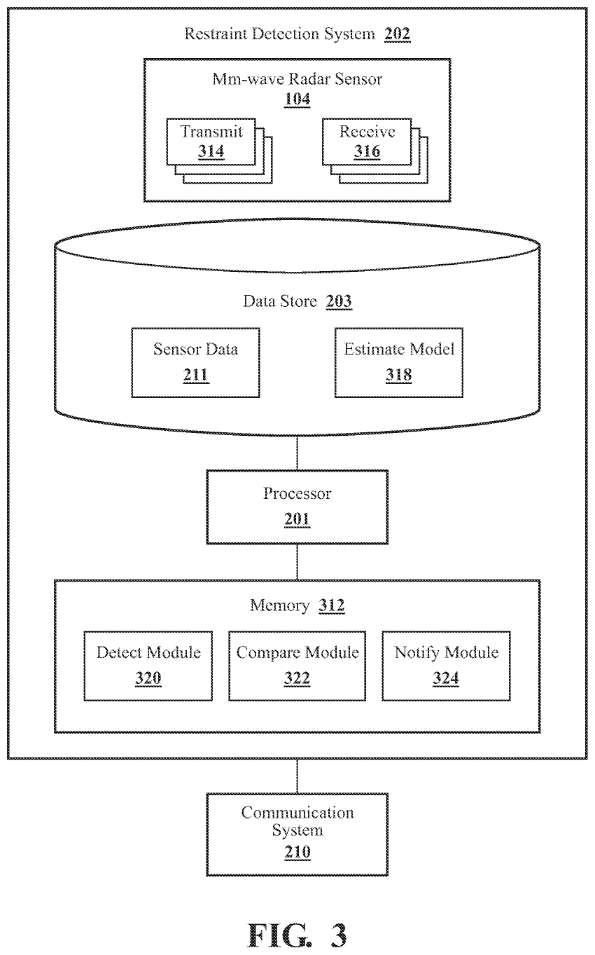

Some of the possible elements of the vehicle 200 are shown in FIG. 2 and will be described along with subsequent figures. However, a description of many of the elements in FIG. 2 will be provided after the discussion of FIGS. 3-8 for purposes of brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements. In any case, the vehicle 200 includes a restraint detection system 202 that is implemented to perform methods and other functions as disclosed herein relating to improving passenger safety via detecting improper/proper usage of passenger restraint devices, where improper usage may be usage that could result in passenger injury and/or that does not conform to laws, regulations, and/or manufacturer or safety guidelines.

As will be discussed in greater detail, the restraint detection system 202, in various embodiments, is implemented partially within the vehicle 200, and as a cloud-based service. For example, in one approach, functionality associated with at least one module of the restraint detection system 202 is implemented within the vehicle 200 while further functionality is implemented within a cloud-based computing system. Thus, the restraint detection system 202 may include a local instance at the vehicle 200 and a remote instance that functions within the cloud-based environment.

Moreover, the restraint detection system 202, as provided for within the vehicle 200, functions in cooperation with a communication system 210. In general, the elements of the vehicle 200 may communicate with one another and externally via the communication system 210. For example, the vehicle 200 elements may be connected to a wireless communication system 210 for transmission of information to a cloud or other remote computing device. Also via the communication system, the elements of the vehicle 200 may be connected to other elements and components, such as data stores 203 and processors 201 for storage and processing of vehicle and environmental sensor data.

In one embodiment, the communication system 210 communicates according to one or more communication standards. For example, the communication system 210 can include multiple different antennas/transceivers and/or other hardware elements for communicating at different frequencies and according to respective protocols. The communication system 210, in one arrangement, communicates via a communication protocol, such as a WiFi, dedicated short-range communication (DSRC), vehicle-to-infrastructure (V2I), vehicle-to-vehicle (V2V), or another suitable protocol for communicating between the vehicle 200 and other entities in the cloud environment. Moreover, the communication system 210, in one arrangement, further communicates according to a protocol, such as global system for mobile communication (GSM), Enhanced Data Rates for GSM Evolution (EDGE), Long-Term Evolution (LTE), 5G, or another communication technology that provides for the vehicle 200 communicating with various remote devices (e.g., a cloud-based server) and other other systems within the vehicle 200. In any case, the restraint detection system 202 can leverage various wireless communication technologies to provide communications to other entities, such as members of the cloud-computing environment.

With reference to FIG. 3, one embodiment of the restraint detection system 202 of FIG. 2 is further illustrated. The restraint detection system 202 is shown as including a processor 201 from the vehicle 200 of FIG. 2. Accordingly, the processor 201 may be a part of the restraint detection system 202, the restraint detection system 202 may include a separate processor from the processor 201 of the vehicle 200, or the restraint detection system 202 may access the processor 201 through a data bus or another communication path that is separate from the vehicle 200. In one embodiment, the restraint detection system 202 includes a memory 312 that stores a detect module 320, a compare module 322, and a notify module 324. The memory 312 is a random-access memory (RAM), read-only memory (ROM), a hard-disk drive, a flash memory, or another suitable memory for storing the modules 320, 322, and 324. The modules 320, 322, and 324 are, for example, computer-readable instructions that when executed by the processor 201, cause the processor 201 to perform the various functions disclosed herein. In alternative arrangements, the modules 320, 322, and 324 are independent elements from the memory 312 that are, for example, comprised of hardware elements. Thus, the modules 320, 322, and 324 are alternatively application-specific integrated circuits (ASICs), hardware-based controllers, a composition of logic gates, or another hardware-based solution.

As described above, the restraint detection system 202 includes a mm-wave radar sensor 104. In general, a mm-wave radar sensor 104 operates in the mm-wave band. For example, the mm-wave radar sensor 104 may operate in a frequency domain of between 30-300 GHz. As a more specific example, the mm-wave radar sensor 104 may operate between 60-80 GHz. As described above, where cameras and other types of sensors cannot penetrate obscuring elements, the mm-wave radar sensor 104 can see through at least a portion of some materials, such as plastics, fabric, seat coverings, and safety belt webbing.

In an example, the restraint detection system 202, and more particularly the mm-wave radar sensor 104, relies on three-dimensional point cloud mapping to detect objects and the location, position, orientation, and/or movements of objects within the field of view of the mm-wave radar sensor 104. The restraint detection system 202 may generate the point cloud in various ways. From the point cloud, object location, object dimensions, and other object properties may be represented as characteristics of the voxels of the point cloud. Additionally, the restraint detection system 202 may analyze the point cloud to determine or estimate the characteristics of an object, such as the material from which the object is formed. As such, the mm-wave radar sensor 104 can differentiate a passenger restraint device from the passengers, seats, and other objects in the vehicle 200. That is, the mm-wave radar sensor 104 may detect individual objects and their locations within the cabin of the vehicle 100 and may be able to determine 1) whether a detected object is living or inanimate and 2) the material and physical properties of the inanimate object.

In one example, the mm-wave radar sensor 104 may determine the characteristics of occupants (e.g., width, height, posture, etc.). As described below, the restraint detection system 202 may rely on these characteristics when determining an expected or appropriate arrangement of the passenger restraint devices in a vehicle 200 for a given passenger.

In an example, the mm-wave radar sensor 104 includes multiple transmit channels 314 and multiple receive channels 316. As a specific example, the mm-wave radar sensor 104 may include between 10 and 15 transmit channels 314 and between 10 and 15 receive channels 316. Doing so may increase the resolution and accuracy of the generated point cloud map. While scanning the cabin of the vehicle 200, each transmit channel 314 and receive channel 316 may simultaneously and continuously operate.

With more channels, the mm-wave radar sensor 104 may be able to transmit and receive signals from multiple directions simultaneously. This may enable a finer resolution when detecting and tracking objects as each channel 314 and 316 provides additional data points for analysis. In an example, the different channels 314 and 316 may be directed to different areas within the cabin. Thus, multiple channels 314 and 316 allow for broader coverage of the sensing area. By distributing the sensing elements across different channels 314 and 316, the mm-wave radar sensor 104 can detect objects from various angles and positions, reducing blind spots and improving overall coverage. Multiple channels 314 and 316 may also mitigate interference issues by employing beamforming and spatial filtering techniques. These techniques enable the mm-wave radar sensor 104 to focus its energy more precisely on desired targets while suppressing interference from other sources, improving signal-to-noise ratio and detection accuracy. Having more channels 314 and 316 also adds diversity to the sensing process, which renders the mm-wave radar sensor 104 operational in less-than-ideal environments where signal attenuation, reflections, and multipath effects are prevalent. By leveraging multiple channels 314 and 316, the mm-wave radar sensor 104 can adapt to changing conditions and extract useful information from different signal paths, leading to more robust and reliable detection. Still further, in applications where high data throughput is desired, such as in high-speed object tracking or imaging, having more channels 314 and 316 allows the mm-wave radar sensor 104 to process more information simultaneously, thereby increasing the overall throughput and reducing latency. As such, a mm-wave radar sensor 104 may include between 3-20 transmit channels 314 and between 3-20 receive channels 316. As a specific example, the mm-wave radar sensor 104 may have between 15-20 transmit channels 314 and between 15-20 receive channels 316. Doing so may improve sensor fidelity by providing finer resolution, broader coverage, better interference mitigation, increased diversity, and higher throughput, making it more capable of accurately detecting and tracking objects in various scenarios.

Moreover, in one embodiment, the restraint detection system 202 includes the data store 203. The data store 203 is, in one embodiment, an electronic data structure stored in the memory 312 or another data storage device and that is configured with routines that can be executed by the processor 201 for analyzing stored data, providing stored data, organizing stored data, and so on. Thus, in one embodiment, the data store 203 stores data used by the modules 320, 322, and 324 in executing various functions.

In one embodiment, the data store 203 stores sensor data 211 from which a determination of the arrangement of the passenger restraint device relative to a passenger is determined. The sensor data 211 may include the output of the mm-wave radar sensor 104 and other sensors of the vehicle 200. For example, the sensor data 211 may include the point cloud generated by the reflected waves of the mm-wave radar sensor 104. The point cloud is analyzed to identify and differentiate objects within the vehicle 200 and identify the location of the objects within the field of view.

The sensor data 211 may include other information as well. For example, as described below, the restraint detection system 202 may determine the characteristics of objects in the cabin of the vehicle 200. While in some examples these characteristics may be determined based on the output of the mm-wave radar sensor 104, these characteristics may be determined based on the output of other sensors. For example, occupant presence in a seat and/or an ignition state of the vehicle 200 may trigger a determination of the propriety of a passenger restraint device usage. As such, the sensor data 211 may include sensors from which occupant presence may be detected (e.g., seat pressure sensors, camera output, etc.) and sensors from which vehicle state may be detected (e.g., ignition sensors). In another example, the characteristics of the passenger may be relied on when determining whether a particular arrangement of a passenger restraint device conforms to legal, regulatory, or manufacturer and safety guidelines. In this example, either the mm-wave radar sensor 104 or some other sensor output may be analyzed to determine the characteristics (e.g., height, weight, posture, and/or position) of the passenger. Such output may be stored as sensor data 211 within the data store 203.

In one embodiment, the data store 203 stores the sensor data 211 along with, for example, metadata that characterizes various aspects of the sensor data 211. For example, the metadata can include location coordinates (e.g., longitude and latitude), relative map coordinates or tile identifiers, time/date stamps from when the separate sensor data 211 was generated, and so on.

In one embodiment, the data store 203 further includes an estimate model 318 which may be relied on by the compare module 322 to estimate an expected arrangement of the passenger restraint device relative to a passenger in the vehicle 200. In an example, the restraint detection system 202 is a machine-learning system. In general, a machine-learning system identifies patterns based on previously unseen data. In the context of the present application, a machine-learning restraint detection system 202 relies on some form of machine learning, whether supervised, unsupervised, reinforcement, or any other type, to classify whether a detected passenger restraint device is positioned across a passenger as expected for the safety and security of that passenger.

In an example, the estimate model 318 is a supervised model that is trained with an input data set and optimized to meet a set of specific outputs. In this example, the estimate model 318 may include training data. That is, a supervised estimate model 318 may be trained to identify proper/improper restraint device usage based on mm-wave radar sensor data (e.g., point cloud data). In this example, the estimate model 318 is trained to characterize the point cloud based on historical point clouds with metadata indicating the historic clouds as either characterizing expected or unexpected restraint usage, with unexpected restraint usage being characterized as not conforming to legal, regulatory, manufacturer, safety, or other guidelines. Specifically, the training data may include historic point cloud representations of different types and sizes of passengers and different arrangements of passenger restraint devices for comparison with point clouds generated from the mm-wave radar sensor 104 output. That is, the restraint detection system 202 may be trained to recognize various conditions within the cabin of the vehicle 200 and characterize such as expected or not. In an example, training may be based on the training data or may be performed by exposing the restraint detection system 202 to various conditions.

In another example, an unsupervised estimate model 318 is trained with an input data set but is not optimized to meet a set of specific outputs; instead, it is trained to classify based on common characteristics. As another example, the estimate model 318 may be a self-trained reinforcement model based on trial and error. In any case, the estimate model 318 includes the weights (including trainable and non-trainable), biases, variables, offset values, algorithms, parameters, and other elements that operate to output a likely identity, class, and movement of the detected lifeforms based on the sensor data 211. Examples of machine-learning models include, but are not limited to, logistic regression models, Support Vector Machine (SVM) models, naïve Bayes models, decision tree models, linear regression models, k-nearest neighbor models, random forest models, boosting algorithm models, and hierarchical clustering models. While particular models are described herein, the estimate model 318 may be of various types intended to identify and classify lifeforms based on determined characteristics.

In an example, the estimate model 318 may be stored locally in the data store 203. In an example, portions of the estimate model 318 may be stored remotely (for example in cloud storage) for on-demand access by the restraint detection system 202 in processing sensor data 211.

The restraint detection system 202 may include a detect module 320 which, in one embodiment, includes instructions that cause the processor 201 to 1) control the mm-wave radar sensor 104 to transmit mm-wave radar waves towards a seat of a vehicle 200 and 2) detect, from reflected mm-wave radar waves, an arrangement of a concealed metallic marker within a passenger restraint device of the seat relative to a passenger in the seat. That is, the detect module 320 may determine, using mm-wave radar sensor 104 output, whether a passenger restraint device is positioned as expected. This determination may be based on the orientation of the passenger restraint device, the amount of webbing extended, the physical characteristics of a passenger, and/or the relative position of different metallic markers in the passenger restraint device, or other marker and passenger characteristics.

Specifically, the detect module 320 may include an instruction that activates the transmit channels 314 and the receive channels 316 of the mm-wave radar sensor 104. In an example, the activation may be triggered by any number of events. For example, the detect module 320 may initiate a mm-wave radar scan when the vehicle 200 is turned on and/or when a passenger is identified in a particular vehicle seat. As such, the detect module 320 may be operatively connected to vehicle state and/or occupancy sensors. As described above, the detection of characteristics/expected usage of a passenger restraint device may be on a per-seat basis. As such, the detect module 320 may individually control the mm-wave radar sensor 104 specific to that seat or a general vehicle-wide mm-wave radar sensor 104 to transmit waves and receive reflected waves.

The detect module 320 may also detect certain characteristics of the passenger and the passenger restraint device based on the reflected waves. That is, the detect module 320 may generate the point cloud from the mm-wave radar sensor data and identify the location, position, orientation, and other material and/or physical properties of different objects within the field of view of the mm-wave radar sensor 104. As particular examples, the detect module 320 may differentiate the passenger restraint device from other objects within the field of view of the mm-wave radar sensor 104, including the passenger across which the passenger restraint device is positioned. In an example, the differentiation between a passenger and the passenger restriant device is based on the content of the respective objects. For example, humans are water-based living organisms. In contrast, a passenger restraint device such as a safety belt may not have water but may include an embedded and concealed metallic marker. As described above, the waves of the mm-wave radar sensor 104 may interact differently with these different materials such that the detect module 320 may differentiate elements based on the different reactions of the waves with different materials.

The detect module 320 may also be able to determine the position and location of the different objects as well as different sub-features of the objects. For example, the detect module 320 may be able to determine the position of the head and shoulders of a passenger and may be able to determine the position of different markers within the passenger restraint device. In an example, such a determination of the position and location of different objects may be based on the output of the mm-wave radar sensor 104 or other sensors such as in-cabin cameras.

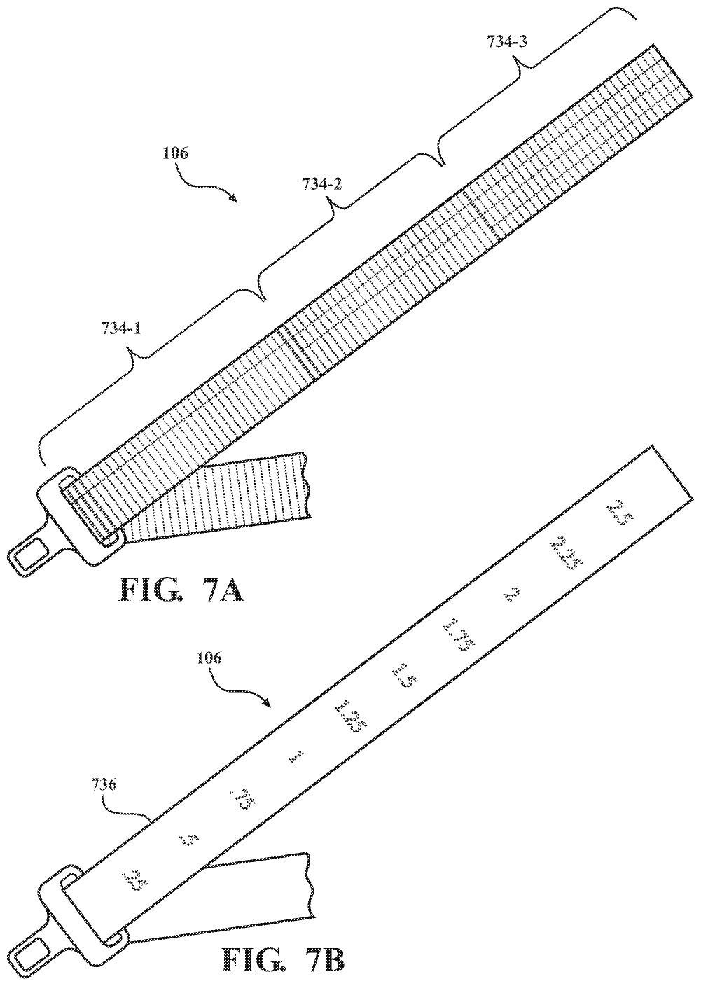

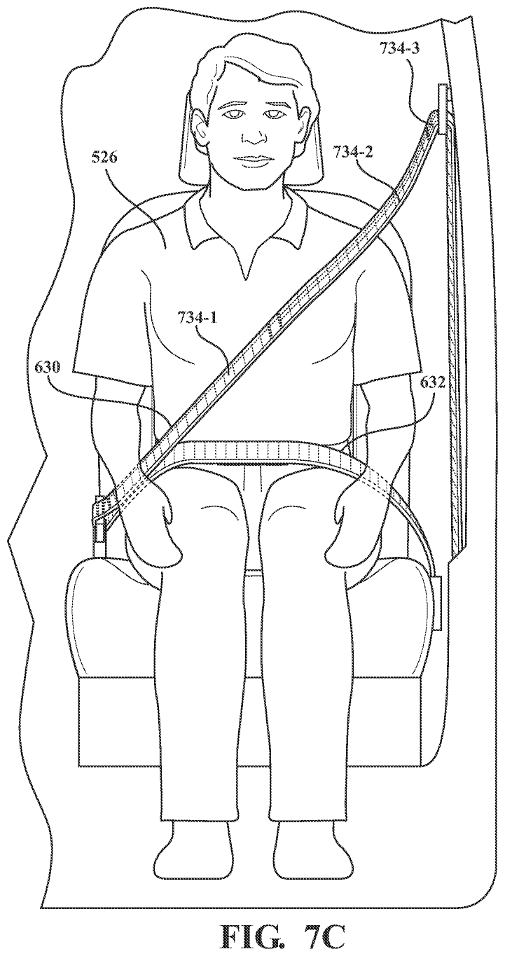

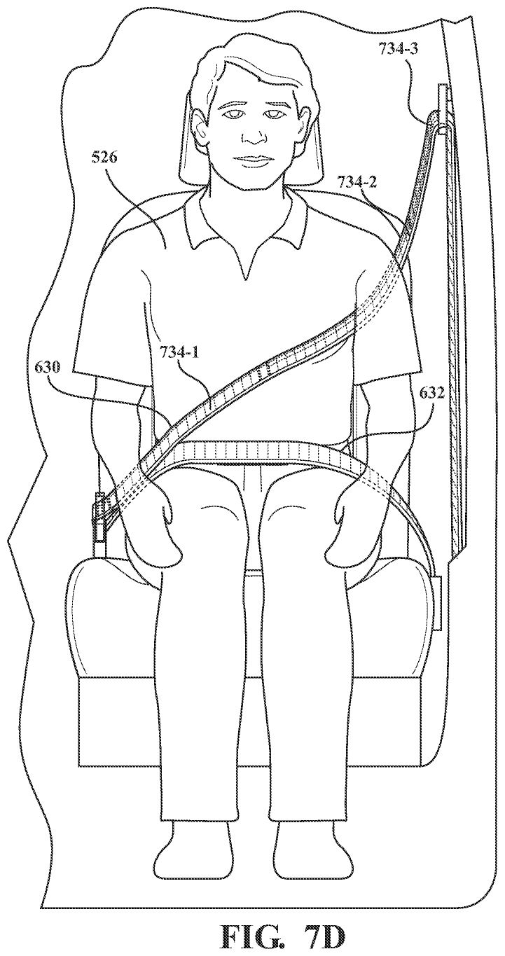

In a particular example, the detect module 320 determines the amount of webbing of the passenger restraint device extended from a spool. That is, improperly worn passenger restraint devices may result in more or less than an expected amount of safety belt webbing being extended from the spool. In this example, the detect module 320 may analyze the detected length-varying pattern of a metallic thread concealed within a safety belt to determine how much of the safety belt is extended. Additional details regarding an evaluation of the proper restraint device usage based on an extended length of a passenger restraint device are provided below in connection with FIGS. 7A-7D.

In one approach, the detect module 320 implements and/or otherwise uses a machine learning algorithm. As described herein, a machine learning algorithm includes but is not limited to deep neural networks (DNN), including transformer networks, convolutional neural networks, recurrent neural networks (RNN), etc., Support Vector Machines (SVM), clustering algorithms, Hidden Markov Models, and so on. It should be appreciated that the separate forms of machine learning algorithms may have distinct applications, such as agent modeling, machine perception, and so on. In one configuration, the machine learning algorithm is embedded within the detect module 320 to perform object detection and tracking based on the sensor data 211. In one particular example, the machine-learning model may be a neural network that includes any number of 1) input nodes that receive sensor data 211, 2) hidden nodes, which may be arranged in layers connected to input nodes and/or other hidden nodes and which include computational instructions for computing outputs, and 3) output nodes connected to the hidden nodes which generate an output indicative of the existence, movement, and classification of an object from the millimeter-wave radar sensor data 211.

Of course, in further aspects, the detect module 320 may employ different machine learning algorithms or implement different approaches for performing object detection and tracking. Whichever particular approach the detect module 320 implements, the detect module 320 provides an output of an identification, classification, and/or estimated location of a passenger restraint device relative to a passenger and an identification classification and/or estimated location of the passenger. In any case, the output of the detect module 320 is transmitted to the compare module 322 to determine whether the detected arrangement of the passenger restraint device is expected (i.e., conforming to legal, regulatory, and/or safety guidelines).

The restraint detection system 202 may include a compare module 322 which, in one embodiment, includes instructions that cause the processor 201 to estimate an expected arrangement of the passenger restraint device relative to the passenger and compare such to the detected arrangement of the passenger restraint device. That is, it may be expected for a passenger restraint device to be in a particular arrangement to ensure passenger safety. The compare module 322 may rely on the estimate model 318 to evaluate appropriate passenger restraint device usage. For example, the estimate model 318 may be a machine-learning model that is trained based on historical data to identify proper and appropriate passenger restraint device arrangements.

As an example, it may be expected that an over-the-shoulder safety belt is diagonally positioned across the trunk of the passenger. In this example, the compare module 322 may expect the over-the-shoulder safety belt to have a diagonal orientation. The compare module 322 may compare the output of the detect module 320 against this expected arrangement to determine whether or not the passenger restraint device is arranged as expected to ensure passenger safety.

In an example, the compare module 322 may estimate the expected arrangement based on passenger characteristics. For example, more belt webbing may be expected to be extended for a larger passenger, i.e., an adult, compared to an adolescent teen. As such, the compare module 322 may, relying on the estimate model 318 and the output of the detect module 320, determine whether a detected arrangement of the passenger restraint device is similar to the expected arrangement of the passenger restraint device. For example, the detect module 320 may determine that an adult male is sitting in a second-row seat of the vehicle 200. The detect module 320 may also determine that a first amount of safety belt webbing is extended across the adult male. However, the compare module 322 may estimate that an expected amount of webbing extended across an adult male with similar features as the adult male currently in the seat is a second amount, which second amount is less than the first amount. This may indicate an abnormal condition of the passenger restraint device, such as the safety belt being overly extended and positioned below the adult male's shoulder for comfort.

In one approach, the compare module 322 implements and/or otherwise uses a machine learning algorithm. As described herein, a machine learning algorithm includes but is not limited to deep neural networks (DNN), including transformer networks, convolutional neural networks, recurrent neural networks (RNN), etc., Support Vector Machines (SVM), clustering algorithms, Hidden Markov Models, and so on. It should be appreciated that the separate forms of machine learning algorithms may have distinct applications, such as agent modeling, machine perception, and so on. In one configuration, the machine learning algorithm is embedded within the compare module 322 to perform expected arrangement estimation and comparison of a detected arrangement to an expected arrangement. In one particular example, the machine-learning model may be a neural network that includes any number of 1) input nodes that receive the output of a detect module 320 and an expected arrangement, 2) hidden nodes, which may be arranged in layers connected to input nodes and/or other hidden nodes and which include computational instructions for computing outputs, and 3) output nodes connected to the hidden nodes which generate an output indicative of the proper/improper donning of a passenger restraint device.

Of course, in further aspects, the compare module 322 may employ different machine learning algorithms or implement different approaches for performing restraint device arrangement analysis. Whichever particular approach the compare module 322 implements, the compare module 322 provides an output of an identification of a properly or improperly worn passenger restraint device. In any case, the output of the compare module 322 is transmitted to the notify module 324 to generate and present a notification of the condition. In this way, the restraint detection system 202 may warn vehicle passengers of improper and potentially unsafe conditions relating to a passenger restraint device.

It should be appreciated that the compare module 322, in combination with the estimate model 318, can form a computational model such as a neural network model. In any case, the compare module 322, when implemented with a neural network model or another model in one embodiment, implements functional aspects of the estimate model 318 while further aspects, such as learned weights, may be stored within the data store 203. Accordingly, the estimate model 318 is generally integrated with the compare module 322 as a cohesive, functional structure.

Moreover, it should be appreciated that machine learning algorithms are generally trained to perform a defined task. Thus, the training of the machine learning algorithm is understood to be distinct from the general use of the machine learning algorithm unless otherwise stated. That is, the restraint detection system 202 or another system generally trains the machine learning algorithm according to a particular training approach, which may include supervised training, self-supervised training, reinforcement learning, and so on. In contrast to training/learning of the machine learning algorithm, the restraint detection system 202 implements the machine learning algorithm to perform inference. Thus, the general use of the machine learning algorithm is described as inference.

The restraint detection system 202 may include a notify module 324 which, in one embodiment, includes instructions that cause the processor 201 to generate a notification responsive to the reflected mm-wave radar sensor 104 waves that indicate that the arrangement of the passenger restraint device is different than the expected arrangement of the passenger restraint device. That is, the notify module 324 may receive an output of the compare module 322 and present the associated notification.

The notification may take various forms, such as audible, visual, or haptic. For example, the notification may be presented visually on a human-machine interface of the vehicle 200. The content of the notification may also be varied. For example, the notification may indicate that an actual arrangement of a passenger restraint device differs from an expected (e.g., safe, complaint, etc.) arrangement of the passenger restraint device, indicate the location of the non-compliant arrangement, and/or provide instructions regarding a remedial measure to be taken. For example, the notification may indicate to a child caretaker that a child car seat chest strap is positioned too low and should be raised to ensure the safety of the child. While particular notifications are described herein, the notify module 324 may generate various types of notifications.

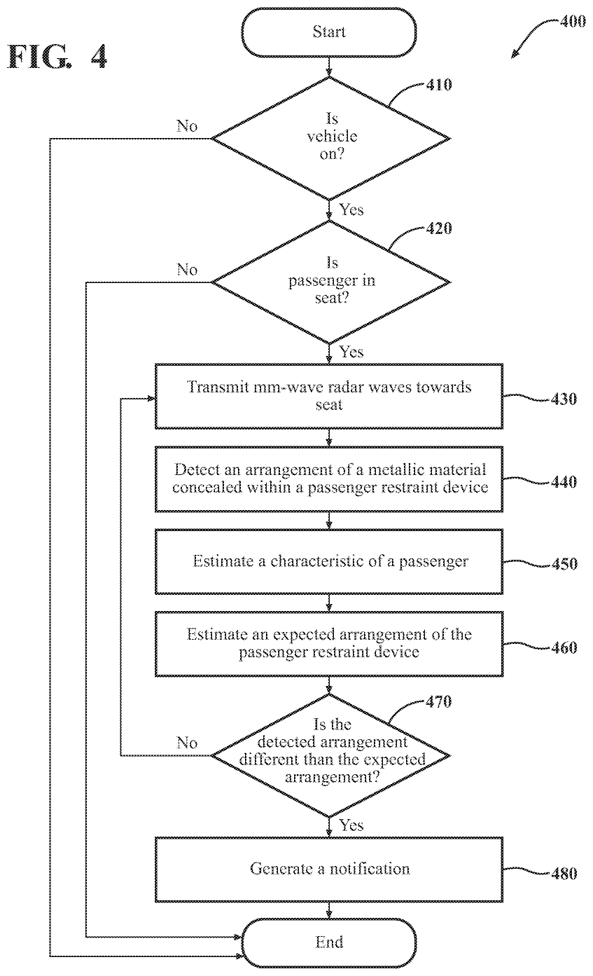

Additional aspects of ensuring passenger safety based on detecting usage of passenger restraint devices that are compliant with legal, regulatory, and/or safety guidelines will be discussed in relation to FIG. 4. FIG. 4 illustrates a flowchart of a method 400 that is associated with detecting characteristics of a passenger restraint device in a vehicle 200 relative to a passenger. Method 400 will be discussed from the perspective of the restraint detection system 202 of FIGS. 1, and 2. While method 400 is discussed in combination with the restraint detection system 202, it should be appreciated that the method 400 is not limited to being implemented within the restraint detection system 202 but is instead one example of a system that may implement the method 400.

As described above, the initiation of the restraint detection may be based on any number of triggering events. For example, the restraint detection system 202 may include instructions that cause the processor 201 to control the mm-wave radar sensor 104 based on at least one of an indication that the vehicle 200 is turned on or an indication that the passenger is in the seat. Specifically at 410, the detect module 320 determines whether the vehicle 200 is turned on. Such a determination may be based on a sensor of the vehicle 200, such as an ignition sensor or another type of vehicle state sensor. If the vehicle 200 is not on, mm-wave radar sensing is bypassed.

If the vehicle 200 is turned on, at 420 the detect module 320 determines whether a passenger is in a monitored seat. This may be determined by any variety of sensors of a vehicle 200, such as a pressure sensor within a seat of a vehicle or camera images depicting a passenger in a seat. Other sensors may be used to determine whether a passenger is in a monitored seat. In an example, multiple seats in the vehicle 200 are monitored, whether by a unique mm-wave radar sensor 104 or by a vehicle-wide mm-wave radar sensor 104. If no seat within the field of view of the particular mm-wave radar sensor 104 is occupied, mm-wave radar sensing may be bypassed for that seat. By comparison, when a seat monitored by a particular mm-wave radar sensor 104 is occupied, at 430, the detect module 320 controls the mm-wave radar sensor 104 to transmit mm-wave radar waves towards a monitored seat. That is, the detect module 320 activates the transmit channels 314 and the receive channels 316 of the mm-wave radar sensor 104 to transmit waves and receive reflected waves.

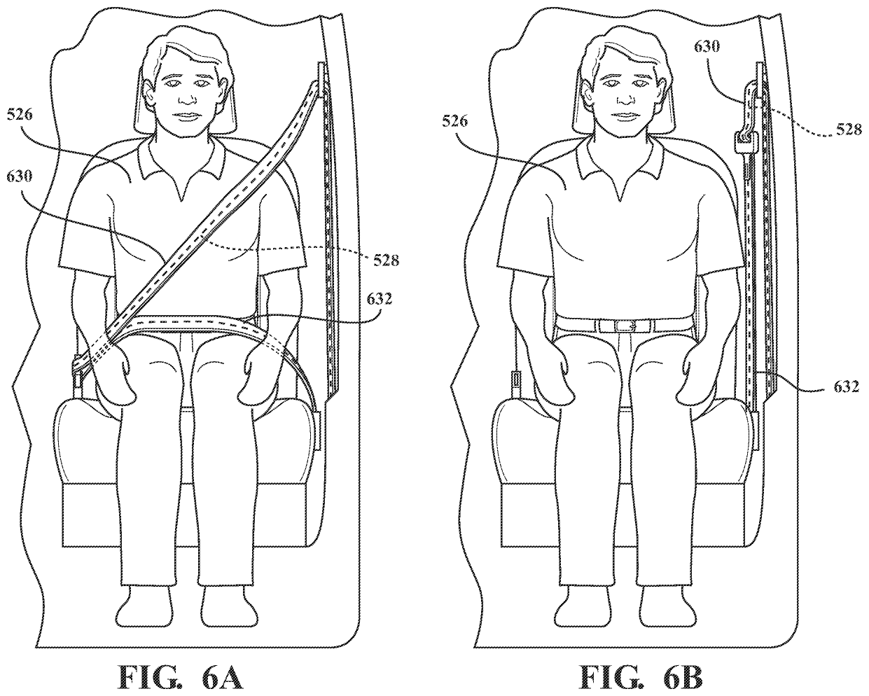

At 440, the detect module 320 detects a concealed metallic marker arrangement within a passenger restraint device. As described above, a passenger restraint device may be embedded with concealed metallic markers such as a metallic wire or thread that is detectable by the mm-wave radar sensor 104, even though visually hidden. As different materials reflect the mm-wave waves differently, the detect module 320 can differentiate the metallic markers from adjacent objects, such as the passenger restraint device webbing/plastic, and determine the arrangement (e.g., position, orientation, exposed portions, position relative to other restraint devices) of the passenger restraint device. In one example, as depicted in FIGS. 6A and 6B, detecting the arrangement of the concealed metallic markers within the passenger restraint device includes detecting the orientation of the metallic markers. Additional details are provided below.

In the example depicted in FIGS. 7A-7D, detecting the arrangement of the concealed metallic markers includes detecting an extended amount of the passenger restraint device (e.g., an amount of webbing extending from a spool). In this example, the passenger restraint device may be embedded with metallic threads formed in a length-based pattern. Accordingly, the detect module 322 determines the amount of metallic thread extended from the spool by recognizing and processing the length-based variation in the form of the concealed metallic thread within the passenger restraint device. Additional details are provided below.

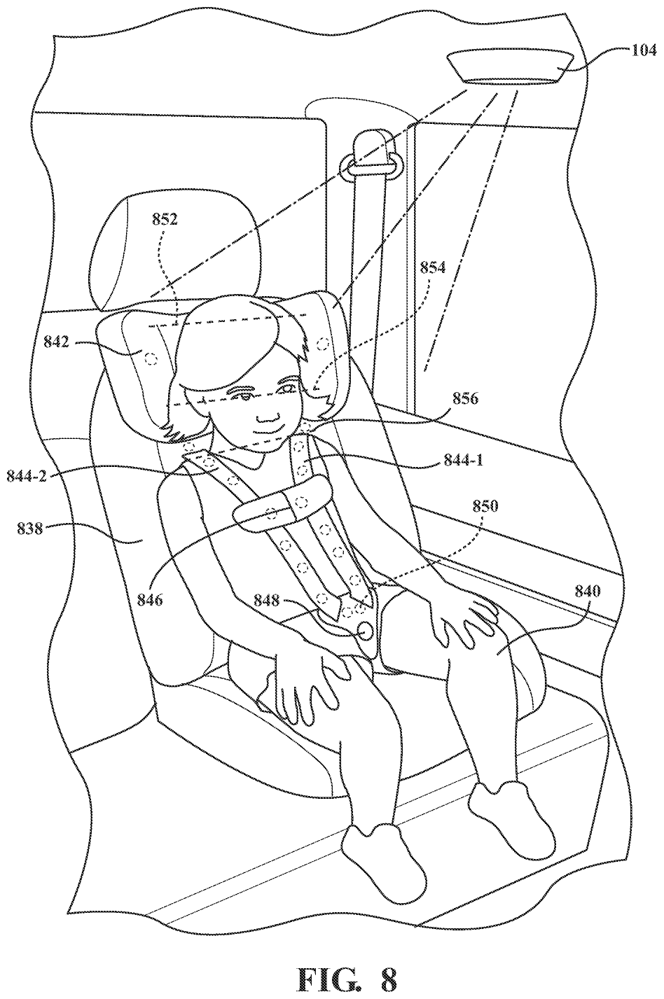

In the example depicted in FIG. 8, detecting the arrangement of the concealed metallic marker includes detecting the position/location of various child restraint devices (e.g., buckles, straps, head restraints) of a child car seat. In this example, the arrangement of the concealed metallic markers may be defined based on their position relative to portions of the child (e.g., the child's head and shoulders). Additional details are provided below. In any case, the detected arrangement indicates whether passenger restraint devices are used as expected to ensure passenger safety.

At 450, the detect module 320 estimates a characteristic of the passenger, such as the passenger's position within the seat or the physical characteristics of the passenger, such as passenger size, weight, height, structure, and/or posture. In some examples, these physical characteristics of the passenger may define the appropriate or expected arrangement of the passenger restraint device. For example, a larger child may dictate a higher head restraint and/or shoulder strap. In an example, the detect module 320 relies on mm-wave radar sensor 104 output to determine the characteristics of the passenger. Additionally or alternatively, the detect module 320 may rely on other sensors, such as in-cabin cameras, to determine the characteristics of the passengers. While particular reference is made to particular characteristics of a passenger, other characteristics of the passenger may be detected.

At 460, the compare module 322 estimates an expected arrangement of the passenger restraint device. As described above, the safe use of a passenger restraint device is associated with expected arrangements (e.g., location, position, amount of extended material, relative position of buckles indicate a buckle is latched) of the passenger restraint device. As such, the compare module 322, which may be a machine-learning model trained to identify the expected arrangements, may determine what is expected for a given passenger restraint device and given passenger characteristics. For example, given the passenger restraint device is an over-the-shoulder safety belt, the compare module 322 may estimate that the expected arrangement of the over-the-shoulder safety belt is one where the belt is angled.

In some examples, the expected arrangement is based on the physical characteristics of the passenger. For example, the expected angle of the over-the-shoulder safety belt may be dependent upon the height of the passenger in the seat. Specifically, the angle of the over-the-shoulder safety belt would be different for a taller passenger compared to the angle of the belt for a shorter passenger.

As another example, the detected arrangement may include an extended amount of the passenger restraint device. In this example, the compare module 322 may estimate the expected extended amount of the passenger restraint device based on the estimated size of the passenger.

As another example, the detected arrangement may be of child restraint devices in a car seat. For example, a child car seat may include a head restraint, shoulder straps, a chest buckle including two components, and any number of other devices. In this example, an expected position of the head restraint may be that the head restraint aligns with a centerline of the child's head, an expected position of the shoulder strap is that the shoulder strap attachment point to the car seat is within some threshold distance from the shoulder height of the child and that the components of the chest buckle are within a threshold distance of one another (i.e., indicating that they are buckled together).

At 470, the compare module 322 determines whether a detected arrangement differs from an expected one. That is, the compare module 322 may compare the expected arrangement with the detected arrangement to determine if there is a threshold difference between the two. In an example, differences below the threshold level may be attributed to natural variations likely to occur between different instances. In contrast, differences greater than the threshold indicate a less-than-deal or undesirable arrangement of the passenger restraint device. In the example where the detected arrangement is an orientation of the passenger restraint device, the compare module 322 may compare a detected orientation of the passenger restraint device with an expected orientation of the passenger restraint device. In the example where the detected arrangement is the length of the extended safety belt, the compare module 322 may compare a detected extended amount with an expected extended amount. In the example where the detected arrangement is the relative position of child restraint devices to positions on the frame of the child, the compare module 322 may compare the detected relative positions of the child restraint devices with expected relative positions.

If the detected arrangement differs from the expected arrangement by greater than a threshold amount, at 480, the notify module 324 generates a notification indicating the circumstances. By comparison, no notification is generated if the detected arrangement is the same or within a threshold amount of the expected arrangement. As such, the method 400 determines whether a passenger restraint device is properly worn by comparing a point cloud representing detected passenger restraint devices with historical information, which historical information is representative of acceptable arrangements of devices on passengers with a similar build to a passenger across which a restraint device is currently being monitored. This is done notwithstanding the passenger restraint device may be wholly or partially blocked by something within the vehicle 200, such as a blanket, passenger appendage, or other object.

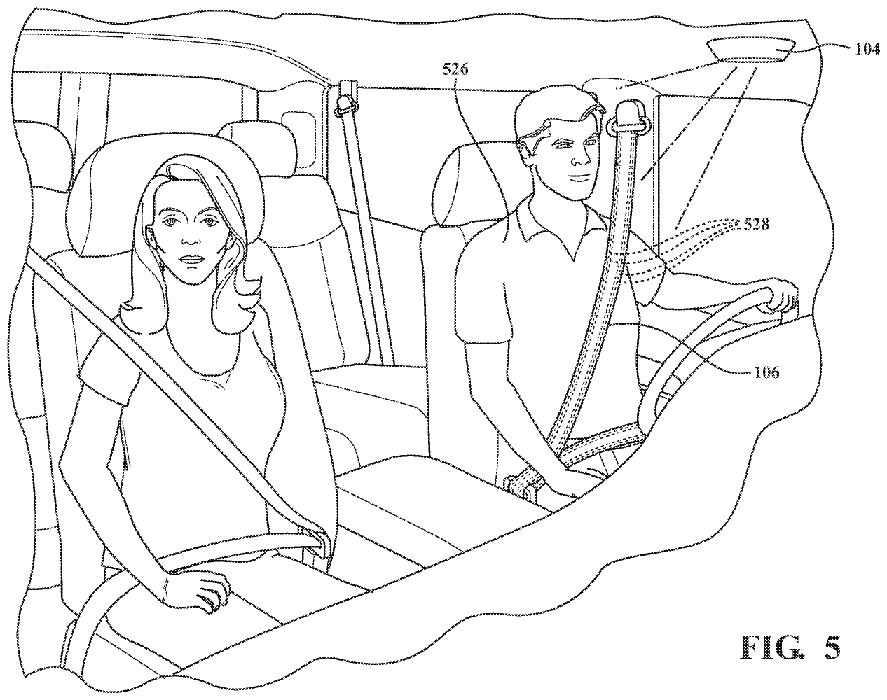

FIG. 5 illustrates one embodiment of a restraint detection system 202 detecting passenger restraint device usage characteristics. Specifically, FIG. 5 depicts an example arrangement of a mm-wave radar sensor 104 within the cabin of the vehicle 200. While FIG. 5 depicts the mm-wave radar sensor 104 at a particular location within the vehicle 200, the mm-wave radar sensor 104 may be positioned at any location within the vehicle 200.

As described above, the passenger restraint device may be a safety belt 106 to be worn across a passenger 526. A metallic marker, such as metallic threads 528 may be embedded within the webbing of the safety belt 106 and are concealed or hidden from view. While such metallic threads 528 may not be detectable by other radar sensors or cameras, the mm-wave radar sensor 104 may be able to penetrate the overlying material to detect the metallic threads 528 within the safety belt 106 and differentiate such from surrounding materials, such as passenger clothing, seat cover material, blankets, etc. As such, the restraint detection system 202 of the present specification detects the arrangement of the passenger restraint device where other systems may not be able to on account of being visibly hidden from a sensor.

While FIG. 5 depicts the internal arrangement of the metallic threads 528 as dashed lines in just a single safety belt 106, the metallic threads 528 may be embedded and concealed within other safety belts 106 of the vehicle 200. Moreover, while FIG. 5 depicts a single mm-wave radar sensor 104 directed towards a single passenger 526, the restraint detection system 202 may include additional mm-wave radar sensors 104 positioned throughout the cabin. In an example, the single mm-wave radar sensor 104 may monitor multiple or all regions of the cabin. In another example, each additional mm-wave radar sensor 104 may monitor an individual seat of the vehicle 200.

FIGS. 6A and 6B illustrate one embodiment of a restraint detection system 202 detecting whether or not a passenger restraint device is improperly worn. As described above, in one example, improper use of a passenger restraint device may be based on the orientation of the passenger restraint device. For example, where the passenger restraint device is an over-the-shoulder safety belt 106 with a trunk portion 630 and a lap portion 632, an expected arrangement (e.g., where the safety belt 106 is worn to prevent injury) may be that the trunk portion 630 is angled over the shoulder of the passenger 526 and the lap portion is horizontal over the legs of the passenger 526 as depicted in FIG. 6A. By comparison, a trunk portion 630 and lap portion 632 of an over-the-shoulder type safety belt 106 that is not worn may be vertical, as depicted in FIG. 6B.

As described above, the restraint detection system 202 may identify when the safety belt 106 is in either of these two arrangements. That is, the nature and characteristics of the reflected waves from the mm-wave radar sensor 104 may indicate the orientation of the metallic threads 528, for example via the generated point clouds. When the trunk portion 630 and the lap portion 632 are each identified as having a vertical orientation (as depicted in FIG. 6B), which would be different from an expected use position of angled and horizontal, respectively (as depicted in FIG. 6A), the compare module 322 may determine that the over-the-shoulder safety belt 106 is not in use and the notify module 324 may generate an associated notification. That is, the restraint detection system 202 may detect and track the location of the metallic threads 528 and differentiate a properly worn over-the-shoulder safety belt 106, as depicted in FIG. 6A from a vertically-oriented over-the-shoulder safety belt 106 that is not in use, as depicted in FIG. 6B.

In another example, the detection of use or non-use of a safety belt 106 may be based on whether or not the metallic markers are detected in a frame. For example, the mm-wave radar sensor 104 may be specifically directed towards a central region of a seat. If the safety belt 106 is in use, a metallic marker would be detected in the central region. By comparison, no metallic marker would be detected in this central region if the safety belt is not in use.

FIG. 7A-7D illustrate one embodiment of a restraint detection system associated with detecting the characteristics of passenger restraint device usage. As described above, in one example, proper usage of a passenger restraint device may be determined based on an amount of extended material (i.e., an extended amount of a safety belt 106 from a spool). In an example, the metallic thread 528 may be embedded within the safety belt 106 in a length-varying pattern. Accordingly, the restraint detection system 202 determines the amount of safety belt 106 extended by determining an amount or portion of the pattern detected by the mm-wave radar sensor 104.

For example, as depicted in FIG. 7A, a leading section 734-1, or a first-extended section, may be defined by a single longitudinal line, while a middle section 734-2, which would be extended after the leading section 734-2, may be defined by two longitudinal lines, and a trailing section 734-3 may be defined by three longitudinal lines. The length of each section 734-1, 734-2, and 734-3 may be further delineated by a number of equally-spaced transverse lines. These lines may be used to determine how much material within each section 734 is extended outside of the spool and across the passenger 526. The detect module 320 may be able to 1) identify the length-based pattern formed by the concealed metallic threads 528, where the pattern varies along the length of the passenger restraint device, and 2) detect from such how much of the safety belt 106 is extended from a spool. Specifically, by identifying which sections 734 are extended (as indicated by the section-specific pattern) and how much of different sections 734 are extended (as indicated by the incremental transverse lines), the detect module 320 may be able to identify an amount (in some cases to the nearest centimeter) of the safety belt 106 that is extended from a spool.

While particular reference is made to a particular length-based pattern (i.e., longitudinal and transverse metallic threads 528), the metallic marker may be formed in any number of patterns or length-indicating formats. For example, as depicted in FIG. 7B, the concealed metallic markers may be formed into alphanumeric characters 736 that indicate the length of the safety belt 106 webbing that is extended. In either example, the detect module 320 may be able to determine an extended amount of the safety belt 106 by reading the alphanumeric characters or other patterns that are exposed, as unexposed portions would not be readable on account of residing within the spool. Additional examples of patterns of metallic markers within the passenger restraint device include machine-readable codes (e.g., barcodes and quick response (QR) codes) and other geometric patterns that may uniquely indicate a particular length segment of a safety belt 106.

As described above, the amount of safety belt 106 that is extended from a spool may indicate improper vs. proper safety belt use. For example, as depicted in FIG. 7C, a properly worn safety belt 106 may have a first amount of a trunk portion 630 of the safety belt 106 extended from the spool as indicated by the concealed metallic threads 528. In the specific example depicted in FIG. 7C, all of a leading section 734-1, all of a middle section 734-2, and a portion of the trailing section 734-3 is extended when the safety belt 106 is properly worn by a particular individual.

By comparison, when a passenger 526 routes the safety belt 106 under their arm, as depicted in FIG. 7D, a greater amount of the trunk portion 630 of the over-the-shoulder safety belt 106 would be extended from the spool. In the specific example depicted in FIG. 7D, a greater portion of the trailing section 734-3 of the trunk portion 630 of the safety belt is extended when the safety belt 106 is improperly worn. The compare module 322 may compare the amount of material that is expected to be extended during safe use (as depicted in FIG. 7C) with the detected amount of actual material extended (as depicted in FIG. 7D) to determine whether or not the passenger 526 is improperly using the passenger restraint device. That is, when more of the trunk portion 630 of the safety belt 106 is detected as being extended as compared to the expected amount, the restraint detection system 202 may infer that some anomalous condition (e.g., the passenger 526 has loosened the belt) exists and may generate a notification of such. Put another way, the restraint detection system 202 may detect an amount of webbing extended (based on reflections of mm-wave radar waves against the patterned metallic threads 528) and form such determine whether or not the detected amount is indicative of proper passenger restraint usage.

As described above, the expected amount may be based on the physical characteristics (e.g., size) of the passenger 526. For example, a safety belt 106 over a larger passenger would have a larger extended trunk portion 630 and lap portion 632 than a smaller passenger. As such, the compare module 322 may rely on the estimate model 318 and detected characteristics of the passenger 526 to determine an appropriate expected amount of extended material.

FIG. 8 illustrates one embodiment of a restraint detection system detecting an improperly used child restraint device. As described above, the restraint detection system 202 may detect the improper placement of various restraint devices, including child restraint devices. A child car seat 838 is a seat that is placed on and attached to a vehicle seat to hold a child 840. The child car seat 838 includes any number of restraint devices such as a head restraint 842, should straps 844-1 and 844-2, a chest buckle 846, and a 5-point harness buckle 848. Each of these components, including plastic components, may be embedded with concealed metallic markers 850 that are out of view. For simplicity, a single instance of a concealed metallic marker 850 is indicated with a reference number.

As with the safety belts 106 depicted in FIGS. 5-7D, improper arrangement of child restraint devices may increase the risk to a child 840 in a child car seat 838 in the event of an accident. Specifically, if restraint devices are improperly placed across the child 840 (e.g., too high or too low), the restraint devices may cause injury or harm to the child in an accident. Accordingly, the mm-wave radar sensor 104 of the restraint detection system 202 may similarly identify and verify the safe arrangement of these child car seat 838 restraint devices and generate notifications when such are in an unsafe or improper arrangement.

In this example, the restraint detection system 202, relying on sensor data 211 from the mm-wave radar sensor 104 or other vehicle sensors, may identify at least one of the head or shoulder positions of the child 840 in the child car seat 838. For example, the detect module 320 may perform image analysis, point cloud analysis, or other sensor output analysis to identify reference points of the child 840, such as a top head height 852, a middle head height 854, and a shoulder height 856.

From this information, the detect module 320 may detect the position of at least one restraint device relative to the position of the child 840. As a specific example, the detect module 320 may detect the position of the head restraint 842 and shoulder straps 844-1 and 844-2 relative to either of the head heights 852 and 854 and the shoulder height 856, respectively. That is, proper placement of the head restraint 842 and shoulder straps 844-1 and 844-2 may be defined, in part, based on their position relative to the head and shoulders of the child 840. For example, if the head restraint 842 is too high or too low, the child 840 may be exposed to an increased risk of injury. By comparison, if the top point of a shoulder strap 844-1 and 844-2 is too high, the child 840 may be less restrained during an impact. As such, the detect module 320 determines a relative difference in these measurements (e.g., head position vs. head restraint position and shoulder position vs. shoulder restraint position). That is, the output of the detect module 320 may be a height difference between a portion of a child's body and a restraint device meant to restrain the child 840.

As another example, the child car seat 838 may include metallic markers 850 at the exit point of the shoulder straps 844-1 and 844-2 from the child car seat 838. That is, a child car seat 838 may have multiple slots in the back of the child car seat 838 through which the shoulder straps 844-1 and 844-2 may be routed. The different slots accommodate children of different heights sitting in the child car seat 838. If the shoulder straps 844-1 and 844-2 are routed through an incorrect slot for the child's height (i.e., a slot that is too high or a slot that is too low), the child may be at improperly restrained (for example if the shoulder straps 844-1 and 844-2 are in a slot that is too high) or too tightly restricted (for example if the shoulder straps 844-1 and 844-2 are in a slot that is too low), which could also cause injury to the child. As such, the detect module 320 determines whether the metallic markers 850 at the exit points of the shoulder straps from the child car seat 838 are visible to determine whether a child is properly seated in the child car seat 838.

Similar to as described above, the compare module 322 estimates an expected head restraint position and/or an estimated shoulder restraint position relative to the head and shoulder positions. That is, the compare module 322 determines what the relative height difference should be between the head restraint/head position of the child and/or between the shoulder restraint/shoulder position of the child to ensure child safety. These expected amounts are compared to detected amounts to determine a difference. A corresponding notification is generated if a difference between the expected and measured amounts is greater than a threshold amount.

In another example, proper restraint device usage may be based on the relative distance between different metallic markers 850. For example, a chest buckle 846 may include two components, each embedded with concealed metallic markers 850. In this example, the detect module 320 may determine the location of each metallic marker and the respective distance between them. A difference greater than a threshold amount may indicate that the buckle 846 is not closed and a notification of such may be presented to a caretaker.

As such, the present restraint detection system 202 provides for the reliable detection of proper and safe passenger safety restraint device usage via detecting and tracking concealed metallic markers within various passenger restraint devices.

FIG. 2 will now be discussed in full detail as an example environment within which the system and methods disclosed herein may operate. In some instances, the vehicle 200 is configured to switch selectively between an autonomous mode, one or more semi-autonomous modes, and/or a manual mode. “Manual mode” means that all of or a majority of the control and/or maneuvering of the vehicle is performed according to inputs received via manual human-machine interfaces (HMIs) (e.g., steering wheel, accelerator pedal, brake pedal, etc.) of the vehicle 200 as manipulated by a user (e.g., human driver). In one or more arrangements, the vehicle 200 can be a manually-controlled vehicle that is configured to operate in only the manual mode.

In one or more arrangements, the vehicle 200 implements some level of automation in order to operate autonomously or semi-autonomously. As used herein, automated control of the vehicle 200 is defined along a spectrum according to the SAE J3016 standard. The SAE J3016 standard defines six levels of automation from level zero to five. In general, as described herein, semi-autonomous mode refers to levels zero to two, while autonomous mode refers to levels three to five. Thus, the autonomous mode generally involves control and/or maneuvering of the vehicle 200 along a travel route via a computing system to control the vehicle 200 with minimal or no input from a human driver. By contrast, the semi-autonomous mode, which may also be referred to as advanced driving assistance system (ADAS), provides a portion of the control and/or maneuvering of the vehicle via a computing system along a travel route with a vehicle operator (i.e., driver) providing at least a portion of the control and/or maneuvering of the vehicle 200.

With continued reference to the various components illustrated in FIG. 2, the vehicle 200 includes one or more processors 201. In one or more arrangements, the processor(s) 201 can be a primary/centralized processor of the vehicle 200 or may be representative of many distributed processing units. For instance, the processor(s) 201 can be an electronic control unit (ECU). Alternatively, or additionally, the processors include a central processing unit (CPU), a graphics processing unit (GPU), an ASIC, a microcontroller, a system on a chip (SoC), and/or other electronic processing units that support operation of the vehicle 200.

The vehicle 200 can include one or more data stores 203 for storing one or more types of data. The data store 203 can be comprised of volatile and/or non-volatile memory. Examples of memory that may form the data store 203 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, solid-state drivers (SSDs), and/or other non-transitory electronic storage medium. In one configuration, the data store 203 is a component of the processor(s) 201. In general, the data store 203 is operatively connected to the processor(s) 201 for use thereby. The term “operatively connected,” as used throughout this description, can include direct or indirect connections, including connections without direct physical contact.

In one or more arrangements, the one or more data stores 203 include various data elements to support functions of the vehicle 200, such as semi-autonomous and/or autonomous functions. Thus, the data store 203 may store map data 205 and/or sensor data 211. The map data 205 includes, in at least one approach, maps of one or more geographic areas. In some instances, the map data 205 can include information about roads (e.g., lane and/or road maps), traffic control devices, road markings, structures, features, and/or landmarks in the one or more geographic areas. The map data 205 may be characterized, in at least one approach, as a high-definition (HD) map that provides information for autonomous and/or semi-autonomous functions.

In one or more arrangements, the map data 205 can include one or more terrain maps 207. The terrain map(s) 207 can include information about the ground, terrain, roads, surfaces, and/or other features of one or more geographic areas. The terrain map(s) 207 can include elevation data in the one or more geographic areas. In one or more arrangements, the map data 205 includes one or more static obstacle maps 209. The static obstacle map(s) 209 can include information about one or more static obstacles located within one or more geographic areas. A “static obstacle” is a physical object whose position and general attributes do not substantially change over a period of time. Examples of static obstacles include trees, buildings, curbs, fences, and so on.

The sensor data 211 is data provided from one or more sensors of the sensor system 213. Thus, the sensor data 211 may include observations of a surrounding environment of the vehicle 200 and/or information about the vehicle 200 itself. In some instances, one or more data stores 203 located onboard the vehicle 200 store at least a portion of the map data 205 and/or the sensor data 211. Alternatively, or in addition, at least a portion of the map data 205 and/or the sensor data 211 can be located in one or more data stores 203 that are located remotely from the vehicle 200.

As noted above, the vehicle 200 can include the sensor system 213. The sensor system 213 can include one or more sensors. As described herein, “sensor” means an electronic and/or mechanical device that generates an output (e.g., an electric signal) responsive to a physical phenomenon, such as electromagnetic radiation (EMR), sound, etc. The sensor system 213 and/or the one or more sensors can be operatively connected to the processor(s) 201, the data store(s) 203, and/or another element of the vehicle 200.

Various examples of different types of sensors will be described herein. However, it will be understood that the embodiments are not limited to the particular sensors described. In various configurations, the sensor system 213 includes one or more vehicle sensors 215 and/or one or more environment sensors. The vehicle sensor(s) 215 function to sense information about the vehicle 200 itself. In one or more arrangements, the vehicle sensor(s) 215 include one or more accelerometers, one or more gyroscopes, an inertial measurement unit (IMU), a dead-reckoning system, a global navigation satellite system (GNSS), a global positioning system (GPS), and/or other sensors for monitoring aspects about the vehicle 200.

As noted, the sensor system 213 can include one or more environment sensors 217 that sense a surrounding environment (e.g., external) of the vehicle 200 and/or, in at least one arrangement, an environment of a passenger cabin of the vehicle 200. For example, the one or more environment sensors 217 sense objects the surrounding environment of the vehicle 200. Such obstacles may be stationary objects and/or dynamic objects. Various examples of sensors of the sensor system 213 will be described herein. The example sensors may be part of the one or more environment sensors 217 and/or the one or more vehicle sensors 215. However, it will be understood that the embodiments are not limited to the particular sensors described. As an example, in one or more arrangements, the sensor system 213 includes one or more radar sensors 219, one or more LiDAR sensors 221, one or more sonar sensors 223 (e.g., ultrasonic sensors), and/or one or more cameras 225 (e.g., monocular, stereoscopic, RGB, infrared, etc.).

Continuing with the discussion of elements from FIG. 2, the vehicle 200 can include an input system 227. The input system 227 generally encompasses one or more devices that enable the acquisition of information by a machine from an outside source, such as an operator. The input system 227 can receive an input from a vehicle passenger (e.g., a driver/operator and/or a passenger). Additionally, in at least one configuration, the vehicle 200 includes an output system 229. The output system 229 includes, for example, one or more devices that enable information/data to be provided to external targets (e.g., a person, a vehicle passenger, another vehicle, another electronic device, etc.).

Furthermore, the vehicle 200 includes, in various arrangements, one or more vehicle systems 231. Various examples of the one or more vehicle systems 231 are shown in FIG. 2. However, the vehicle 200 can include a different arrangement of vehicle systems. It should be appreciated that although particular vehicle systems are separately defined, each or any of the systems or portions thereof may be otherwise combined or segregated via hardware and/or software within the vehicle 200. As illustrated, the vehicle 200 includes a propulsion system 233, a braking system 235, a steering system 237, a throttle system 239, a transmission system 241, a signaling system 243, and a navigation system 245.

The navigation system 245 can include one or more devices, applications, and/or combinations thereof to determine the geographic location of the vehicle 200 and/or to determine a travel route for the vehicle 200. The navigation system 245 can include one or more mapping applications to determine a travel route for the vehicle 200 according to, for example, the map data 205. The navigation system 245 may include or at least provide connection to a global positioning system, a local positioning system or a geolocation system.

In one or more configurations, the vehicle systems 215 function cooperatively with other components of the vehicle 200. For example, the processor(s) 201, the restraint detection system 202, and/or automated driving module(s) 247 can be operatively connected to communicate with the various vehicle systems 231 and/or individual components thereof. For example, the processor(s) 201 and/or the automated driving module(s) 247 can be in communication to send and/or receive information from the various vehicle systems 231 to control the navigation and/or maneuvering of the vehicle 200. The processor(s) 201, the restraint detection system 202, and/or the automated driving module(s) 247 may control some or all of these vehicle systems 231.

For example, when operating in the autonomous mode, the processor(s) 201 and/or the automated driving module(s) 247 control the heading and speed of the vehicle 200. The processor(s) 201 and/or the automated driving module(s) 247 cause the vehicle 200 to accelerate (e.g., by increasing the supply of energy/fuel provided to a motor), decelerate (e.g., by applying brakes), and/or change direction (e.g., by steering the front two wheels). As used herein, “cause” or “causing” means to make, force, compel, direct, command, instruct, and/or enable an event or action to occur either in a direct or indirect manner.

As shown, the vehicle 200 includes one or more actuators 249 in at least one configuration. The actuators 249 are, for example, elements operable to move and/or control a mechanism, such as one or more of the vehicle systems 231 or components thereof responsive to electronic signals or other inputs from the processor(s) 201 and/or the automated driving module(s) 247. The one or more actuators 249 may include motors, pneumatic actuators, hydraulic pistons, relays, solenoids, piezoelectric actuators, and/or another form of actuator that generates the desired control.

As described previously, the vehicle 200 can include one or more modules, at least some of which are described herein. In at least one arrangement, the modules are implemented as non-transitory computer-readable instructions that, when executed by the processor 201, implement one or more of the various functions described herein. In various arrangements, one or more of the modules are a component of the processor(s) 201, or one or more of the modules are executed on and/or distributed among other processing systems to which the processor(s) 201 is operatively connected. Alternatively, or in addition, the one or more modules are implemented, at least partially, within hardware. For example, the one or more modules may be comprised of a combination of logic gates (e.g., metal-oxide-semiconductor field-effect transistors (MOSFETs)) arranged to achieve the described functions, an ASIC, programmable logic array (PLA), field-programmable gate array (FPGA), and/or another electronic hardware-based implementation to implement the described functions. Further, in one or more arrangements, one or more of the modules can be distributed among a plurality of the modules described herein. In one or more arrangements, two or more of the modules described herein can be combined into a single module.

Furthermore, the vehicle 200 may include one or more automated driving modules 247. The automated driving module(s) 247, in at least one approach, receive data from the sensor system 213 and/or other systems associated with the vehicle 200. In one or more arrangements, the automated driving module(s) 247 use such data to perceive a surrounding environment of the vehicle. The automated driving module(s) 247 determine a position of the vehicle 200 in the surrounding environment and map aspects of the surrounding environment. For example, the automated driving module(s) 247 determines the location of obstacles or other environmental features including traffic signs, trees, shrubs, neighboring vehicles, pedestrians, etc.

The automated driving module(s) 247 either independently or in combination with the restraint detection system 202 can be configured to determine travel path(s), current autonomous driving maneuvers for the vehicle 200, future autonomous driving maneuvers and/or modifications to current autonomous driving maneuvers based on data acquired by the sensor system 213 and/or another source. In general, the automated driving module(s) 247 functions to, for example, implement different levels of automation, including advanced driving assistance (ADAS) functions, semi-autonomous functions, and fully autonomous functions, as previously described.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-8, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. The systems, components and/or processes also can be embedded in a computer-readable storage, such as a computer program product or other data program storage device, readable by a machine, tangibly embodying a program of instructions executable by the machine to perform methods and processes described herein. These elements also can be embedded in an application product which comprises the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. A non-exhaustive list of the computer-readable storage medium can include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or a combination of the foregoing. In the context of this document, a computer-readable storage medium is, for example, a tangible medium that stores a program for use by or in connection with an instruction execution system, apparatus, or device.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™ Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

1. A system, comprising:
a millimeter-wave (mm-wave) radar sensor;
a processor; and
a memory storing machine-readable instructions that, when executed by the processor, cause the processor to:
control the mm-wave radar sensor to transmit mm-wave radar waves towards a seat of a vehicle;
detect, from reflected mm-wave radar waves, an arrangement of a concealed metallic marker within a passenger restraint device of the seat relative to a passenger in the seat;
estimate an expected arrangement of the passenger restraint device relative to the passenger; and
generate a notification responsive to the reflected mm-wave radar waves indicating that the arrangement of the passenger restraint device is different than the expected arrangement of the passenger restraint device.

2. The system of claim 1, wherein the machine-readable instructions that, when executed by the processor, cause the processor to detect the arrangement of the concealed metallic marker within the passenger restraint device comprise machine-readable instructions that, when executed by the processor, cause the processor to detect the arrangement of the concealed metallic marker within at least one of:
a vehicle safety belt;
a head restraint of a child car seat;
a shoulder strap of the child car seat; or
a buckle of the child car seat.

3. The system of claim 1, wherein:
the machine-readable instruction that, when executed by the processor, causes the processor to detect the arrangement of the concealed metallic marker within the passenger restraint device comprises a machine-readable instruction that, when executed by the processor, causes the processor to detect an orientation of the passenger restraint device; and
the machine-readable instructions further comprise a machine-readable instruction that, when executed by the processor, causes the processor to compare a detected orientation of the passenger restraint device with an expected orientation of the passenger restraint device.

4. The system of claim 1, wherein:
the machine-readable instructions further comprise a machine-readable instruction that, when executed by the processor, causes the processor to detect a position of the passenger; and
the machine-readable instruction that, when executed by the processor, causes the processor to estimate the expected arrangement of the passenger restraint device comprises a machine-readable instruction that, when executed by the processor, causes the processor to estimate the expected arrangement of the passenger restraint device based on the position of the passenger.

5. The system of claim 1, wherein:
the machine-readable instructions further comprise a machine-readable instruction that, when executed by the processor, causes the processor to estimate a size of the passenger;
the machine-readable instruction that, when executed by the processor, causes the processor to detect the arrangement of the concealed metallic marker within the passenger restraint device comprises a machine-readable instruction that, when executed by the processor, causes the processor to detect an extended amount of the passenger restraint device; and
the machine-readable instruction that, when executed by the processor, causes the processor to estimate the expected arrangement of the passenger restraint device comprises a machine-readable instruction that, when executed by the processor, causes the processor to estimate an expected extended amount of the passenger restraint device based on an estimated size of the passenger.

6. The system of claim 5, wherein the machine-readable instruction that, when executed by the processor, causes the processor to estimate the expected extended amount of the passenger restraint device comprises a machine-readable instruction that, when executed by the processor, causes the processor to identify a length-based variation in a form of the concealed metallic marker.

7. The system of claim 6, wherein the machine-readable instruction that, when executed by the processor, causes the processor to identify the length-based variation in the form of the concealed metallic marker comprises a machine-readable instruction that, when executed by the processor, causes the processor to identify, within the concealed metallic marker, at least one of:
alphanumeric characters formed by the concealed metallic marker; or
a length-based pattern formed by the concealed metallic marker, where the length-based pattern varies along a length of the passenger restraint device.

8. The system of claim 1, wherein:
the machine-readable instructions further comprise a machine-readable instruction that, when executed by the processor, causes the processor to identify at least one of a head position or a shoulder position of a child in a child car seat;
the machine-readable instruction that, when executed by the processor, causes the processor to detect the arrangement of the concealed metallic marker within the passenger restraint device comprises a machine-readable instruction that, when executed by the processor, causes the processor to detect at least one of a head restraint position or a shoulder restraint position relative to the head position and the shoulder position, respectively; and
the machine-readable instruction that, when executed by the processor, causes the processor to estimate the expected arrangement of the passenger restraint device comprises a machine-readable instruction that, when executed by the processor, causes the processor to estimate at least one of an expected head restraint position or an expected shoulder restraint position relative to the head position and the shoulder position, respectively.

9. The system of claim 1, wherein the mm-wave radar sensor comprises:
multiple transmit channels; and
multiple receive channels.

10. The system of claim 1, wherein the machine-readable instructions that, when executed by the processor, cause the processor to control the mm-wave radar sensor to transmit the mm-wave radar waves towards the seat of the vehicle comprise a machine-readable instruction that, when executed by the processor, cause the processor to control the mm-wave radar sensor based on at least one of:
an indication that the vehicle is turned on; or
an indication that the passenger is in the seat.

11. (canceled)

12. (canceled)

13. (canceled)

14. (canceled)

15. (canceled)

16. A method, comprising:
controlling a millimeter-wave (mm-wave) radar sensor to transmit mm-wave radar waves towards a seat of a vehicle;
detecting, from reflected mm-wave radar waves, an arrangement of a concealed metallic marker within a passenger restraint device of the seat relative to a passenger in the seat;
estimating an expected arrangement of the passenger restraint device relative to the passenger; and
generating a notification responsive to the reflected mm-wave radar waves indicating that the arrangement of the passenger restraint device is different than the expected arrangement of the passenger restraint device.

17. The method of claim 16 wherein:
the method further comprises detecting a characteristic of the passenger; and
estimating the expected arrangement of the passenger restraint device estimating the expected arrangement of the passenger restraint device based on the characteristic of the passenger.

18. The method of claim 16, wherein:
detecting the arrangement of the concealed metallic marker within the passenger restraint device comprises detecting an orientation of the passenger restraint device; and
the method further comprises comparing a detected orientation of the passenger restraint device with an expected orientation of the passenger restraint device.

19. The method of claim 16, wherein:
the method further comprises estimating a size of the passenger;
detecting the arrangement of the concealed metallic marker within the passenger restraint device comprises detecting an extended amount of the passenger restraint device by identifying a length-based variation in a form of the concealed metallic marker within the passenger restraint device; and
estimating the expected arrangement of the passenger restraint device comprises estimating an expected extended amount of the passenger restraint device based on an estimated size of the passenger.

20. The method of claim 16, wherein:
the method further comprises identifying at least one of a head position or a shoulder position of a child in a child car seat;
detecting the arrangement of the concealed metallic marker within the passenger restraint device comprises detecting at least one of a head restraint position or a shoulder restraint position relative to the head position and the shoulder position, respectively; and
estimating the expected arrangement of the passenger restraint device comprises estimating at least one of an expected head restraint position or an expected shoulder restraint position relative to the head position and the shoulder position, respectively.

21. A passenger restraint system, comprising:
a webbing configured to be draped across a passenger; and
a concealed metallic marker, detectable by a millimeter-wave (mm-wave) radar system, within the webbing, the concealed metallic marker is within the webbing in a pattern that indicates whether the passenger restraint system is worn as expected.

22. The passenger restraint system of claim 21, wherein at least one of a length of an exposed portion of the pattern or an orientation of the exposed portion of the pattern indicates whether the passenger restraint system is worn as expected.

23. The passenger restraint system of claim 21, wherein the pattern comprises at least one of:
alphanumeric characters formed by the concealed metallic marker that indicate a length of the webbing extending from a spool; or
a length-based pattern formed by the concealed metallic marker, where the length-based pattern varies along the length of the webbing.

24. The passenger restraint system of claim 21, wherein:
the webbing is a shoulder strap to be angularly draped over a shoulder of the passenger; and
the pattern is to indicate an angle of the shoulder strap across the passenger.

25. The passenger restraint system of claim 21, wherein the webbing is at least one of a shoulder strap or a chest strap of a child restraint device.
